(19) United States
(12) Patent Application Publication
(10) Pub. No.: US 2012/0037612 A1
(43) Pub. Date: Feb. 16, 2012

(54) ELECTRIC HEATING DEVICE

(76) Inventor: Andreas SCHLIPF, Tuttlingen (DE)

(21) Appl. No.: 13/208,816

(22) Filed: Aug. 12, 2011

(30) Foreign Application Priority Data
Aug. 13, 2010 (DE) 20 2010 011 404.7

(51) Int. Cl. H05B 3/06; H01C 17/00

(52) U.S. Cl. 219/542; 29/610.1

(57) ABSTRACT

An electric heating device (100), especially for an injection molding die, has a material tube (101), through which passes a duct (109) for a flowable material, a heater (102, 122, 132) for heating the flowable material when this is present in the duct (109) and a thermocouple (103). The heater (102, 122, 132) is pushed over the material tube (101) or is placed round the material tube (101), so that the material tube (101) is received in an opening passing through the heater (102, 122, 132) along the direction in which the material tube (101) extends. The heater (102, 122, 132) is arranged detachably at the material tube. The thermocouple (103) is arranged at least in some sections between a surface of the material tube (101), which said surface faces away from the duct (109), and the surface of the heater (102, 122, 132), which latter surface faces the duct (109), so that when the heater (102, 122, 132) is detached from the material tube (101), the thermocouple (103) and heater (102, 122, 132) form separate assembly units. A process is provided for manufacturing such an electric heating device, including the steps of manufacturing a heater, inserting a thermocouple into a groove of the heater or of a jacket tube and pushing the heater over the material tube with the thermocouple inserted into the groove, wherein the thermocouple inserted into the groove is clamped during or after the pushing over of the heater.

### CROSS REFERENCE TO RELATED APPLICATIONS

This application claims the benefit of priority under 35 U.S.C. §119 of German Utility Model 20 2010 011 404.7 filed Aug. 13, 2010, the entire contents of which are incorporated herein by reference.

### FIELD OF THE INVENTION

The present invention pertains to an electric heating device, especially for an injection molding tool, with a material tube, through which passes a duct for a flowable material, with a heater for heating the flowable material when this is present in the duct, wherein the heater is pushed over the material tube or is placed around the material tube, so that the material tube is mounted in an opening passing through the heater along the direction in which the material tube extends, and wherein the heater is arranged detachably at the material tube, and with a thermocouple and to a process for manufacturing same.

### BACKGROUND OF THE INVENTION

Such electric heating devices are used, for example, in injection molding dies. They have a material tube with a duct for the flowable material and a heater, which surrounds the outer wall of the material tube and can be removed from the material tube.

Furthermore, accurate temperature monitoring is important, which is achieved in practice by providing a thermocouple, whose sensor tip is brought into contact with the material tube and is fixed there. This means that the thermocouple must pass through the heater, i.e., in a hole, which is prepared in the heater for this purpose and into which the thermocouple must be inserted. An example of such an electric heating device is known, for example, from DE 10 2008 055 640 A1.

It was found in practice that the service lives of thermocouples and heaters, which are used in electric heating devices, are different from each other in practice. However, it is complicated, if at all possible, in the prior-art embodiments to replace a defective thermocouple of a still functioning heater or to use a functioning thermocouple of a defective heater in conjunction with a new heater that is able to function.

### SUMMARY OF THE INVENTION

An object is therefore to provide an electric heater that makes it possible to replace the thermocouple in a simple manner and rapidly and a process for manufacturing same.

The electric heating device according to the present invention comprises a material tube, through which passes a duct for a flowable material and a heater for heating the flowable material when this is present in the duct. The suitable heaters are especially heaters in which the heating element is formed by a heating layer applied to the outer or inner jacket surface according to a plasma process, by printing or in another manner, thick-layer heaters, heaters with a heating element that is inserted into a groove prepared in the inner or outer jacket surface of the heater, and also heaters in which the heating element is embedded in a powder or granular material between the jacket surfaces.

The heater is arranged detachably at the material tube and is especially pushed detachably over the material tube or is placed detachably around the material tube, so that the material tube is received in an opening passing through along the direction in which the material tube extends. This does not expressly require that the material tube must be surrounded by the heater in all directions. Embodiments in which the heater has a recess passing through it in parallel to the longitudinal axis thereof are included as well.

Furthermore, the electric heating device comprises at least one thermocouple.

The thermocouple is arranged according to the present invention at least in some sections between a surface of the material tube facing away from the duct and the surface of the heater facing the duct, so that the thermocouple and heater form separate assembly units when the heater is detached from the material tube.

The present invention is based on the discovery that the defined positioning and fixing of the thermocouple, which is absolutely necessary for obtaining reliable and reproducible measured temperature values, can be achieved when arranging the thermocouple between the heater and the material tube by an interaction with these components. This entails that when one of these components is removed, the fixing of the thermocouple is automatically no longer guaranteed, either, so that it can be detached easily or by itself from the other assembly units of the electric heating device.

It is especially advantageous if, when separating the heater from the material tube, the thermocouple and heater form separate assembly units, which can fall apart and thus they are not, as in a less preferred embodiment of the connection compared to this, connected to one another in an easily detachable manner by holding means, which do not bring about a positioning and fixing of the thermocouple. In the preferred embodiment with separate assembly units, which can fall apart, it is, on the contrary, sufficient for this to pull off the heater from the material tube to replace the thermocouple and, if necessary, to tilt it, unless the thermocouple had already fallen off in the process.

In an especially compact embodiment of the electric heating device, the thermocouple is guided, at least in some sections, in a groove in the material tube or in a groove of the heater. It is especially advantageous if the groove passes completely through the material tube or heater in the direction in which the material tube extends, i.e., in the direction of flow of the material to be injected.

In an advantageous variant of the present invention, the groove is prepared in the heater by deforming the heater. It was found that, for example, compaction of the heater on a calibrating mandrel, which has a burr in the form of the groove to be prepared, leads to suitable grooves, which permits, moreover, cost-effective manufacture, because, contrary to the situation seen especially in case of the use of grooves prepared by machining, no additional process step has to be performed any more.

A preferred process for manufacturing an electric heating device according to the present invention correspondingly has the steps of manufacturing a heater, inserting the thermocouple into a groove of the heater or of the material tube and pushing the heater with the thermocouple inserted into the groove over the material tube, wherein the thermocouple inserted into the groove is jammed during or after the pushing over of the heater. Provisions are made in an especially advantageous embodiment for the groove to be arranged in the heater and to be impressed into the heater during the compaction performed in connection with the manufacture of the heater. This can be achieved especially by the compaction being performed on a calibrating mandrel, which has a burr in the form of the desired groove.

An especially simple manner of positioning and fixing the thermocouple is obtained if the thermocouple is fixed by being clamped a least in some sections, especially in the area of its sensor tip, between the heater and material tube. Clamping in the area of the sensor tip also ensures, moreover, intimate thermal contact between the temperature-sensitive area of the thermocouple and the material tube, which makes possible especially reliable measurements.

There are a number of possibilities of bringing about this clamping action, each of which has different advantages.

Provisions are made in a first embodiment, which is advantageous because of the simple and cost-effective possibility of manufacture associated with it, for a reduction of the cross section of the opening passing through the heater to be present in the area in which the sensor tip is located, so that the clamping action is produced.

Provisions are made in an alternative advantageous embodiment for an end section of the thermocouple to be guided in a groove in the material tube or in a groove in the heater, whose depth decreases in the direction of the sensor tip of the thermocouple to a value that is lower than the diameter of the sensor tip, so that the clamping action is produced. This embodiment makes possible an especially compact and space-saving design.

Provisions are made in yet another embodiment for the heater to have a recess, into which a wedge can be inserted, wherein in the state in which it is inserted into the recess, said wedge clamps the sensor tip of the thermocouple between heater and material tube. The special advantage of this embodiment is that even removal of the wedge is sufficient to make it possible to replace the thermocouple. The advantage of a compact design can be additionally embodied in a variant of this embodiment if the wedge has a guide for receiving a section, especially of the sensor tip, of the thermocouple. In addition, the wedge may be shaped in this variant such that it surrounds the sensor tip of the thermocouple on all surfaces that are not in contact with the material tube, so that there is no direct contact any more between the heater and sensor tip of the thermocouple. If the material from which the wedge is made is selected properly, thermal uncoupling from the heater can be achieved as a result, which contributes to coming close to the ideal situation, in which the temperature values determined depend exclusively on the temperature of the material to be injected.

Provisions are made in another embodiment for the heater to comprise a spring element, which presses the thermocouple onto the material tube, so that the clamping action is produced. This approach has the advantage that the risk of pinching of the thermocouple, which would lead to damage thereto, is minimized because an effective limitation of the forces acting on the thermocouple can be achieved by selecting the stress of the spring element.

Moreover, especially reliable measured values can be determined with the thermocouple if the sensor tip of the thermocouple is clamped indirectly between the heater and material tube via a heat-conductive piece of material, which is thermally uncoupled from the heater and has a groove or hole, in which the sensor tip of the thermocouple is mounted.

In another advantageous variant of the present invention, the thermocouple has a positioning section, in which the cross section of the thermocouple is larger in at least one direction of the cross-sectional area than in sections of the thermocouple located adjacent to this section, and the heater has means for locking this section against being displaced in and/or opposite the direction in which the thermocouple extends. It is ensured in this embodiment that no displacement of the thermocouple takes place when the heater is pushed over the material tube, so that the correct positioning of the sensor tip at the desired site continues to be guaranteed.

An especially simple possibility of embodying the positioning section is to attach a sleeve to the thermocouple, e.g., by pressing, soldering or welding. However, it is also possible to deform the thermocouple in a defined area, e.g., to press the thermocouple flat in the direction of the jacket tube, as a result of which the thermocouple would expand, i.e., widen in the direction at right angles thereto, which is located in the cross-sectional surface.

The positioning sections are then advantageously fixed by a recess in the projection or in a projection on the surface of the heater, which faces the jacket tube.

The present invention will be explained in more detail below on the basis of drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1a is a three-dimensional view of the general design of an electric heating device according to the present invention;

FIG. 1b is the heater pulled off from the electric heating device in FIG. 1a;

FIG. 1c is a top view of the electric heating device from FIG. 1a as viewed from the direction of the terminals of the thermocouple and heating element;

FIG. 1d is a section along line A-A in FIG. 1c;

FIG. 1e is an enlarged section along line B-B in FIG. 1d;

FIG. 1f is an enlarged section along line B-B in FIG. 1d in a second embodiment;

FIG. 1g is an enlarged section along line B-B in FIG. 1d in a third embodiment;

FIG. 2a is an enlarged section along line C-C from FIG. 1d in case of the use of a first embodiment of a clamping mechanism;

FIG. 2b is an enlarged view of detail D from the view in FIG. 1d in case of the use of the clamping mechanism from FIG. 2a;

FIG. 3a is an enlarged section along line C-C in FIG. 1d in case of the use of a second embodiment of a clamping mechanism;

FIG. 3b is an enlarged view of detail D from the view in FIG. 1d in case of the use of the clamping mechanism according to FIG. 3a;

FIG. 4a is an enlarged section along line C-C from FIG. 1d in case of the use of a third embodiment of a clamping mechanism;

FIG. 4b is an enlarged view of detail D from the view in FIG. 1d in case of the use of the clamping mechanism according to FIG. 4a;

FIG. 5a is an enlarged section along line C-C in FIG. 1d in case of the use of a fourth embodiment of a clamping mechanism;

FIG. 5b is an enlarged view of detail D from the view in FIG. 1d in case of the use of the clamping mechanism according to FIG. 5a;

FIG. 6a is an enlarged section along line C-C in FIG. 1d in case of use of a fifth embodiment of a clamping mechanism;

FIG. 6b is an enlarged view of detail D from the view in FIG. 1d in case of the use of the clamping mechanism according to FIG. 6a;

FIG. 7a is an enlarged section along line C-C in FIG. 1d in case of the use of a sixth embodiment of a clamping mechanism;

FIG. 7b is an enlarged sectional view of detail D from the view in FIG. 1d in case of the use of the clamping mechanism from FIG. 6a;

FIG. 8a is an enlarged section along line C-C from FIG. 1d in case of the use of a seventh embodiment of the clamping mechanism;

FIG. 8b is an enlarged view of detail D from the view in FIG. 1d in case of the use of the clamping mechanism according to FIG. 8a;

FIG. 9a is an enlarged section along line C-C from FIG. 1d in case of the use of an eighth embodiment of a clamping mechanism;

FIG. 9b is an enlarged view of detail D from the view in FIG. 1d in case of the use of the clamping mechanism according to FIG. 9a;

FIG. 10a is an enlarged section along line C-C from FIG. 1d in case of the use of a ninth embodiment of a clamping mechanism;

FIG. 10b is an enlarged view of detail D from the view in FIG. 1d in case of the use of the clamping mechanism according to FIG. 10a;

FIG. 11a is an enlarged section along line C-C from FIG. 1d in case of the use of a tenth embodiment of a clamping mechanism;

FIG. 11b is an enlarged view of detail D from the view in FIG. 1d in case of the use of the clamping mechanism according to FIG. 11a;

FIG. 12a is an enlarged section along line C-C from FIG. 1d in case of the use of an eleventh embodiment of a clamping mechanism;

FIG. 12b is an enlarged view of detail D from the view in FIG. 1d in case of the use of the clamping mechanism according to FIG. 12a;

FIG. 13a is an enlarged section along line C-C from FIG. 1d in case of the use of a twelfth embodiment of a clamping mechanism;

FIG. 13b is an enlarged view of detail D from the view in FIG. 1d in case of the use of the clamping mechanism according to FIG. 13a;

FIG. 14a is an enlarged section along line C-C from FIG. 1d in case of the use of a thirteenth embodiment of a clamping mechanism;

FIG. 14b is an enlarged view of detail D from the view in FIG. 1d in case of the use of the clamping mechanism according to FIG. 14a;

FIG. 15a is an enlarged view of detail Y from the view in FIG. 1d in a first variant of the use of as thermocouple with positioning section; and

FIG. 15b is an enlarged view of detail Y from the view in FIG. 1d in a second variant of the use of a thermocouple with positioning section.

### DESCRIPTION OF THE PREFERRED EMBODIMENTS

Referring to the drawings in particular, identical reference numbers are used for identical components of the same exemplary embodiments in all figures.

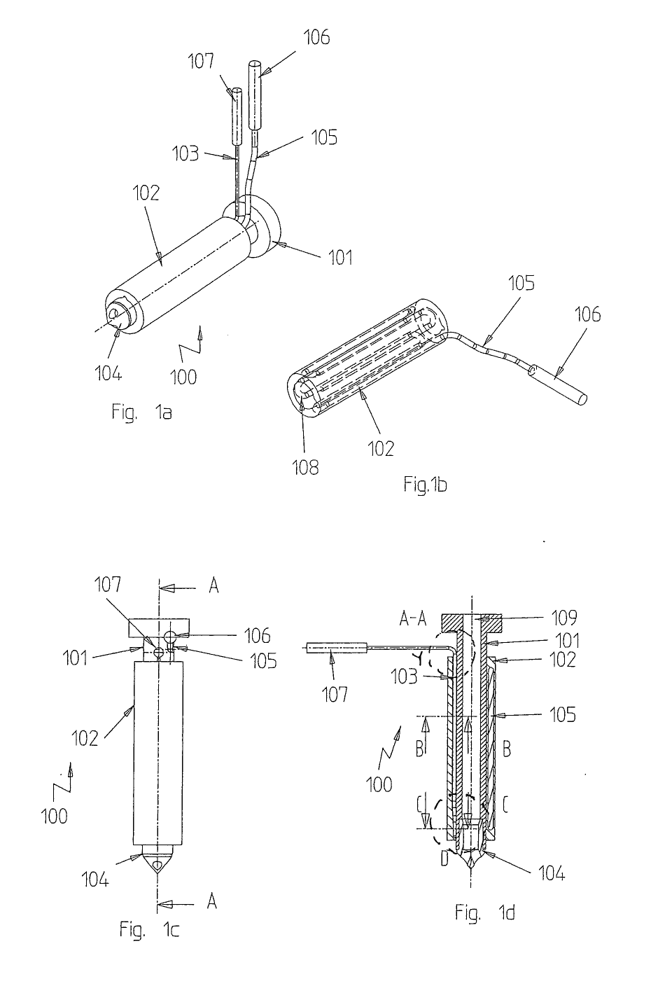

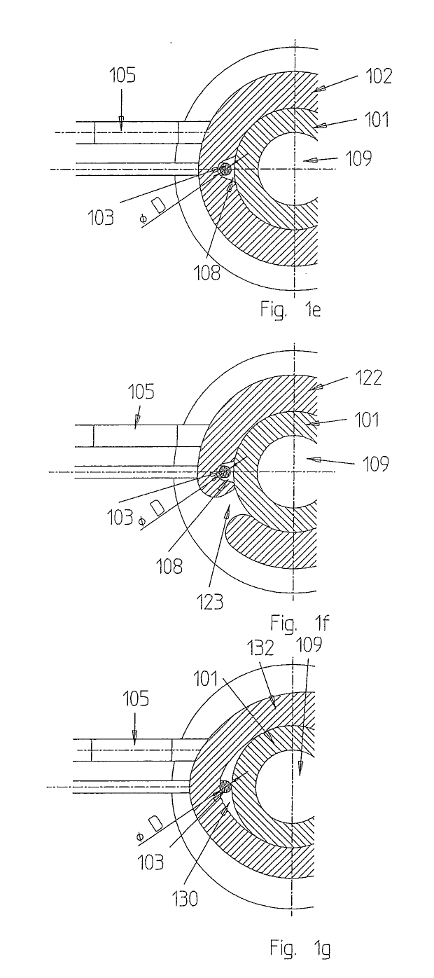

FIG. 1a shows a three-dimensional view of the general design of an electric heating device 100 according to the present invention with material tube 101, heater 102 and thermocouple 103. The material tube has an injection nozzle 104 at the end at which the flowable material is discharged during the operation. The heating element 105 of heater 102, which can be supplied with supply voltage via the connector plug 106, protrudes from the heater 102 on the side facing the machine, not shown, at which the electric heating device 100 is arranged. The thermocouple 103 is connected via a connector plug 107.

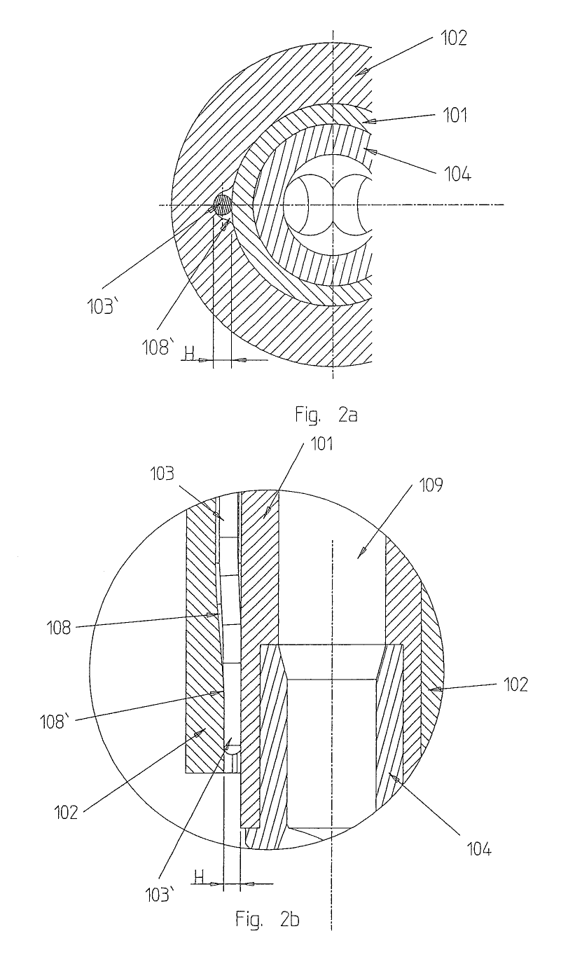

FIG. 1b shows the heater 102 pulled off from the electric heating device from FIG. 1a with the heating element 105 and the connector plug 106. The course of the heating element 105 in the interior of heater 102 is indicated in this form as an example with dash-dotted lines; it is meandering in this example, but it may also be coiled or have any other desired course. In particular, the view of heating element 105 is not shown in any of the enlarged details in FIGS. 2a through 14b in order to make it possible to show clearer views of essential aspects.

It shall be pointed out, in particular, in connection with FIG. 1b that heater 102 has no hole, which would connect its outer and inner jacket surfaces to one another. Such holes are necessary in heaters 102 of electric heating devices known from the state of the art to bring the thermocouple 103 into contact with the material tube 101. This is disadvantageous because, besides the increasing manufacturing technological effort, it entails the necessity to guide the heating element 105 such that it remains intact during the drilling of the hole. The inner jacket surface of heater 102 has, instead, a groove 108 here, in which the thermocouple is guided between the heater 102 and material tube 101, as it will be illustrated below on the basis of FIG. 1d.

Another essential point, which is linked with this, is that the heater 102 is a separate assembly unit not connected to the thermocouple 103. Even though the thermocouple 103 may possibly remain in groove 108, depending on the orientation of the heater 102 when the heater 102 is pulled off from the material tube 101, thermocouple 103 and heater 102 fall apart as two separate assembly units at least after a suitable motion of heater 102.

A section line A-A is defined in FIG. 1c, which shows a top view of the electric heating device 100 from FIG. 1a, viewed from the direction of the terminals 106, 107 of the thermocouple 103 and heating element 102. FIG. 1d shows the section along this line A-A. It can be recognized especially clearly in this view of the heater 100 that a duct 109 for the flowable material, which is to be injected from the electric heating device 100, passes through the material tube 101. Furthermore, the embedding of the heating element 105 in heater 102, which is omitted in FIGS. 1e through 14b discussed below in the interest of a clear view, is shown here once again as well.

Another essential feature, which can be recognized in FIG. 1d especially clearly, is the arrangement of the thermocouple 103 between the material tube 101 and heater 102, more specifically between the surface of the heater 102 facing the material tube 101 (which is defined in the area of a groove by the corresponding surface of the groove) and the surface facing the heater 102. This is brought about concretely over the entire length of the heater 102 by mounting in a groove in the view according to FIG. 1d.

Furthermore, two section lines B-B are shown in FIG. 1d in the middle section of the electric heating device 100 and C-C as well as an area D marked by a circle drawn by broken line in the end section of the electric heating device 100, in which especially the sensitive area of the thermocouple 103 is located, and an area Y marked by a circle drawn in broken line in the initial section of the electric heating device 100 in the area around the feed line of the thermocouple 103.

FIGS. 1e through 15b discussed below show enlarged views of various possibilities of designing the general structure of the electric heating device 100, as it is described in FIGS. 1a through 1d. The individual embodiments can be freely combined with one another, unless they directly contradict each other, especially the embodiments in area B-B, on the one hand, and C-C and D, on the other hand.

FIG. 1e shows a first possibility of arranging the thermocouple 103 of a heater 102 with a ring-shaped cross section 102, which completely surrounds a material tube 101 with ring-shaped cross-section, through which a concentric duct 109 passes. Thermocouple 103, whose diameter is designated by d, is arranged in a groove 108, whose extension is greater than the diameter, so that thermocouple 103 and heater 102 fall apart when the heater 102 is pulled off from the material tube 101.

FIG. 1f shows an enlarged section along line B-B in FIG. 1d in a second embodiment of the heater. The arrangement according to FIG. 1f corresponds to the arrangement according to FIG. 1e with the difference that a recess 123 passes through the heater 122 shown in FIG. 1f over the extension thereof. This makes it possible to design the heater 102 as a clamping heater and thus to achieve fixing of the heater 122 on the material tube 101 in a simple manner.

FIG. 1g shows an enlarged detail along line B-B in FIG. 1d in a third embodiment of the heater. The heater used here is a heater 132 that is not in contact with the material tube 101 over its entire surface facing the material tube 101, but is designed such that an intermediate space 130, which is dimensioned such that the thermocouple 102 with the diameter d can be received therein, remains between heater 132 and material tube 101. The processing step of preparing a groove 108 in the heater or material tube 101, which is often associated with a great effort, is avoided in this embodiment, which reduces the manufacturing costs and manufacturing time.

FIGS. 2a through 14b show different manners in which the general design of an electric heating device according to FIGS. 1a through 1d can be varied in order to obtain a (detachable) fixing of the thermocouple 103 especially in the area of the sensor tip 103′ thereof.

FIG. 2a shows an enlarged sectional view along line C-C in FIG. 1d in case of the use of a first embodiment of a clamping mechanism and FIG. 2b shows an enlarged view of detail D from the view in FIG. 1d in case of the use of the clamping mechanism according to FIG. 2a. As can be best recognized from FIG. 2b, the clamping action is obtained here by the depth of the groove 108 being reduced in the area 108′ of the groove, in which area the sensor tip 103′ of the thermocouple 103 is received, to a value H, which is equal to or smaller than the cross section of the sensor tip 103′ in the clamping direction.

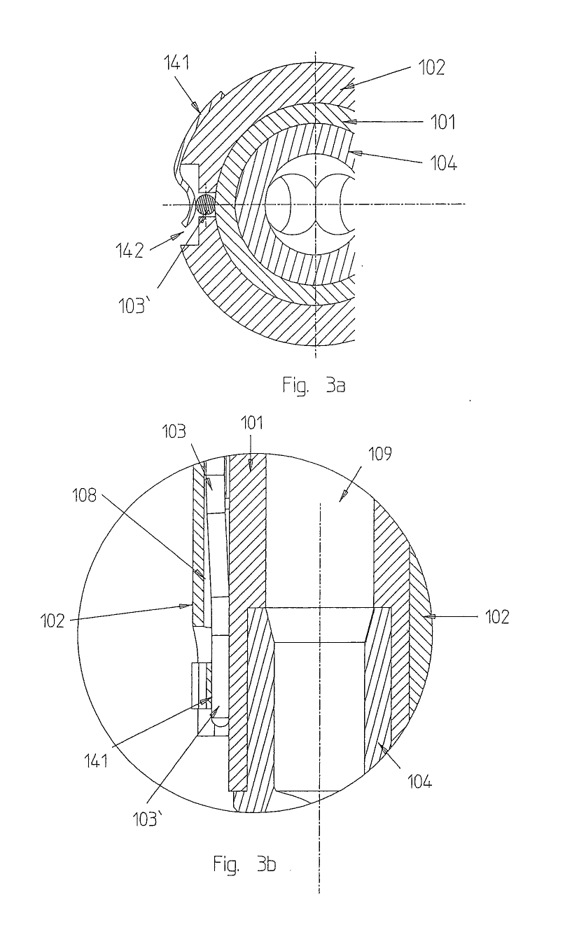

FIG. 3a shows an enlarged section along line C-C in FIG. 1d in case of the use of a second embodiment of a clamping mechanism, and FIG. 3b shows an enlarged view of detail D from the view in FIG. 1d in case of the use of the clamping mechanism according to FIG. 3a. A recess 142, which makes it possible for a spring element 141 attached on one side to the heater 102 to press the sensor tip 103′ onto the material tube 101, is provided in the heater 102 in this embodiment in the area of the sensor tip 103′ of thermocouple 103.

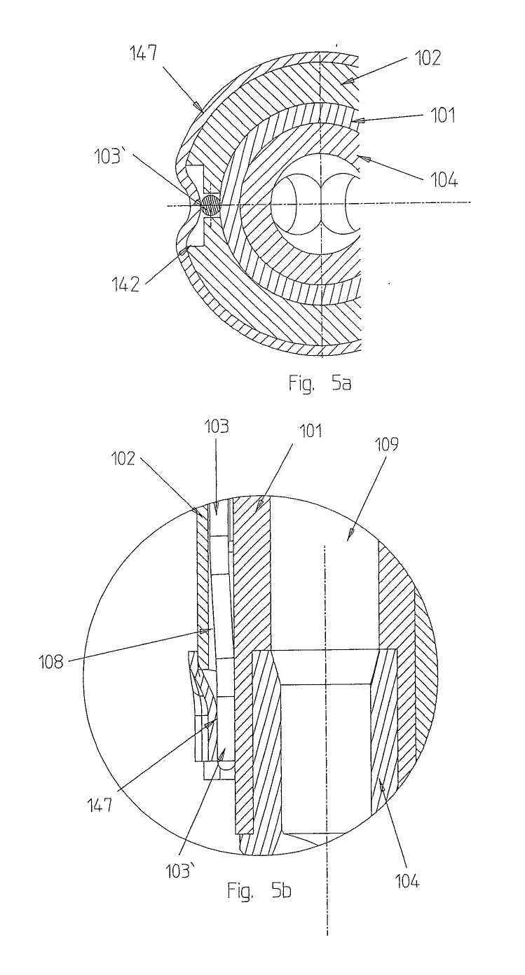

FIG. 5a and FIG. 5b differ from FIG. 3a and FIG. 3b only in respect to the concrete embodiment of the clamping, which is embodied here by a circular ring 147 with an indentation at the site of the sensor tip 103′ of thermocouple 103.

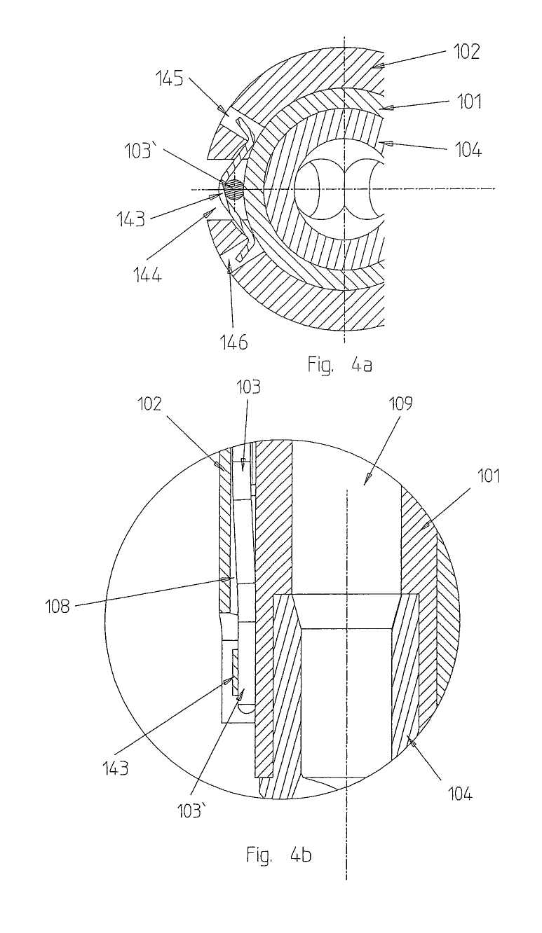

FIG. 4a and FIG. 4b likewise differ from FIG. 3a and FIG. 3b only in respect to the concrete embodiment of the spring clamping. Recess 144 passes through here in the area of the sensor tip 103′ of thermocouple 103 of the heater 102 and the clamping action is obtained by the use of a clip-like spring element 143, which is anchored in recesses 145, 146 of the heater.

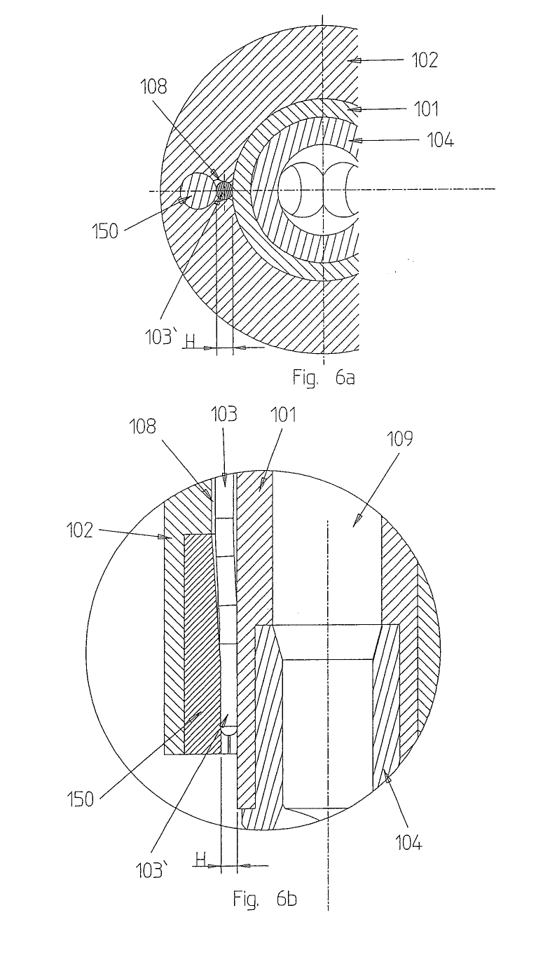

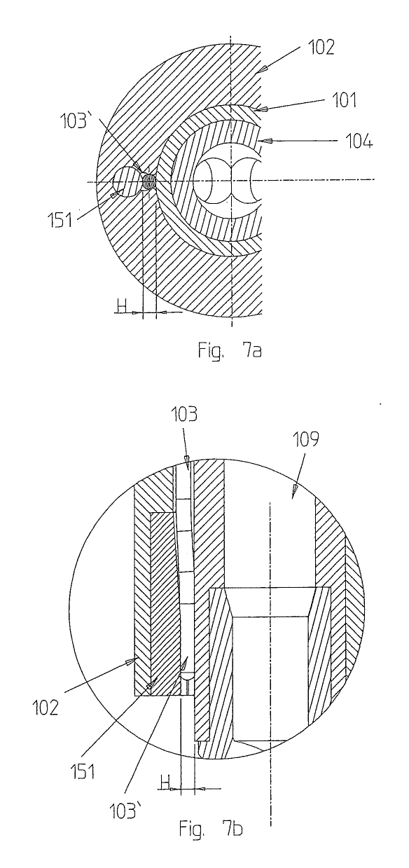

FIG. 6a and FIG. 6b show an embodiment based on another principle of producing the clamping action, namely, the clamping of the sensor tip 103′ of the thermocouple 103 between a wedge 150, which is inserted into a fittingly shaped recess in the heater 102, and the material tube 101. Wedge 150 can act as a closing element, after the removal of which the electric heating device 100 can fall apart into its individual components, material tube 101, heater 102 and thermocouple 103 practically by itself, without application of a significant force. At the same time, it ensures the intimate thermal contact between the sensor tip 103′ and material tube 101, so that reliable measurements are guaranteed.

FIG. 7a and FIG. 7b show a variant of the principle shown in FIGS. 6a and 6b, in which only a wedge 151 of a different shape is provided, whose geometric design permits simpler manufacture of the mount of the wedge 151 in heater 102.

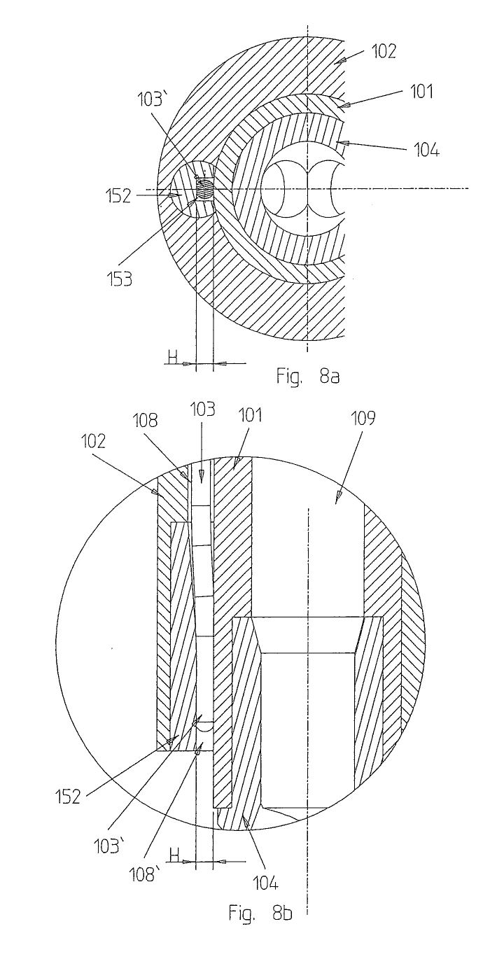

FIGS. 8a and b show a variant of the embodiment according to FIGS. 7a and 7b, in which a wedge 152 with a groove 153 is used. The depth H of this groove 153 is equal to or smaller than the diameter d of the sensor tip 103′ of the thermocouple 103, which said tip is inserted into groove 153. Furthermore, groove 153 surrounds the sensor tip 103′ on all sides, which do not adjoin the material tube 101 and thus contributes to a thermal uncoupling from the heater 102, which contributes to coming closer to the ideal measuring conditions.

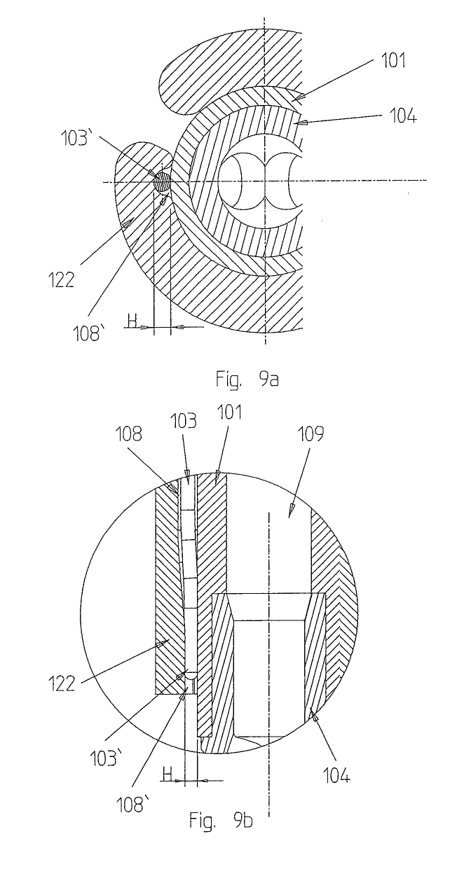

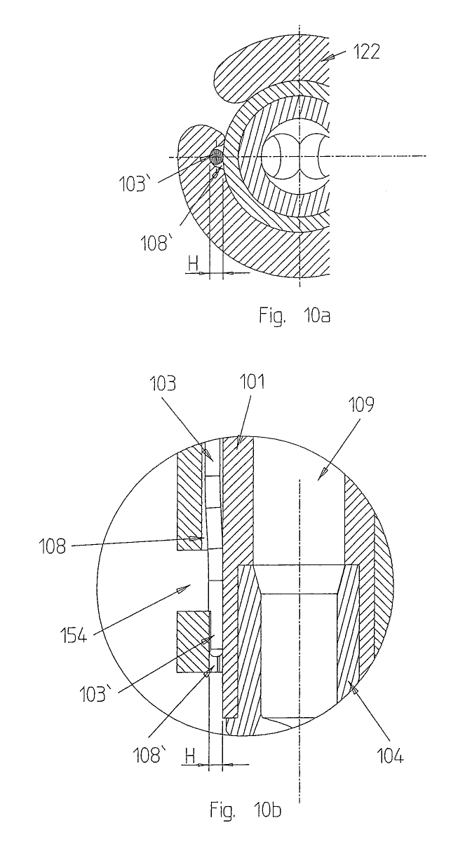

FIG. 9a shows an enlarged section along line C-C in FIG. 1d in case of the use of an eighth embodiment of a clamping mechanism, and FIG. 9b shows a corresponding enlarged view of detail D from the view in FIG. 1d. The clamping mechanism shown here is formed by the direct extrapolation of the clamping mechanism that is shown in FIGS. 2a and 2b to an embodiment with a heater 122, as it is shown in FIG. 1f.

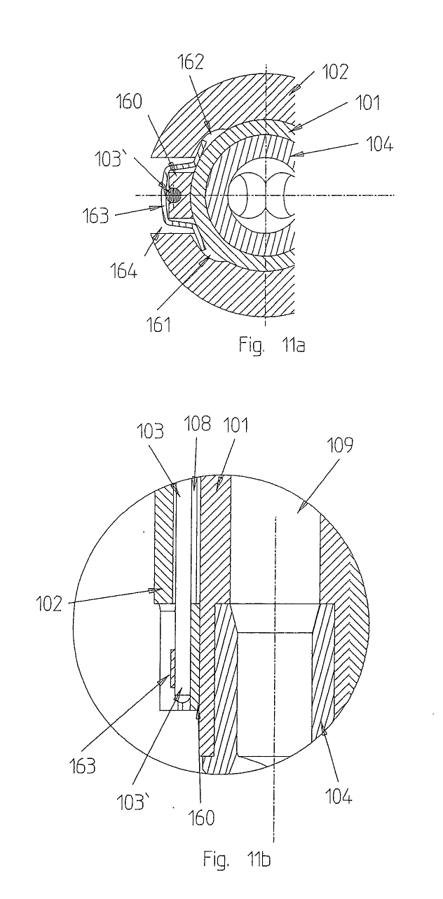

FIGS. 10a and 10b show a clamping mechanism that differs from that shown in FIGS. 9a and 9b only in that the reduction of the depth of the end area 108′ of groove 108, which area receives the sensor tip 103′ of the thermocouple 103, takes place abruptly and that a recess 154, which leads to an at least partial thermal uncoupling of the sensor tip 103′ from the heater 122, is provided in heater 122.

FIGS. 11a and 11b show a variant of the embodiment according to FIGS. 4a and 4b, in which the clamping of the sensor tip 103′ of thermocouple 103 against the material tube 101 takes place indirectly. Sensor tip 103′ is guided in the groove of a block 160 made of a material possessing good heat conductivity, which said block is arranged flatly at the material tube 101 in a recess 164 passing through the heater 102 in the direction of the material tube 101, and is clamped with the material tube 101 together with the block 160 by means of the spring element 163 mounted in recesses 161, 162 in the form of a clip, as a result of which an especially good thermal coupling of the sensor tip 103′ with the material tube 101 and thermal uncoupling from the heater 102 are achieved.

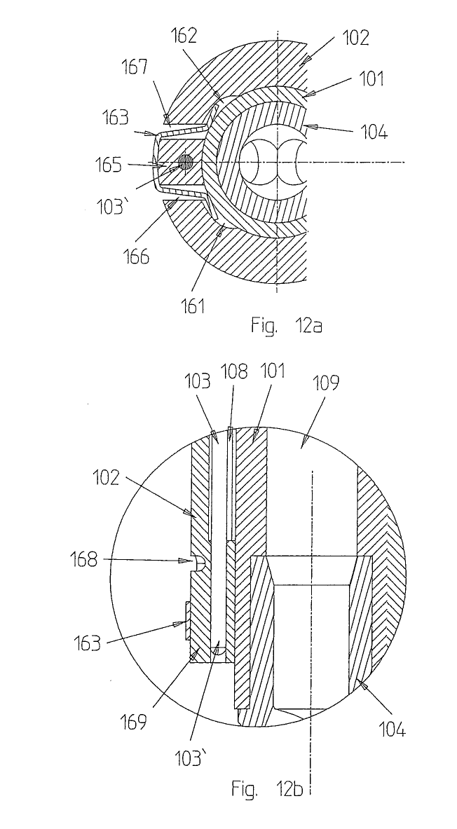

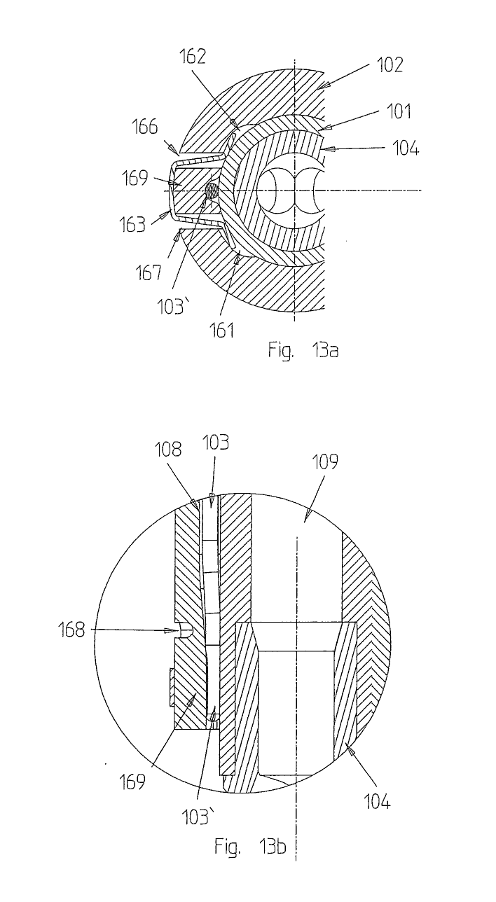

The embodiment according to FIGS. 12a and 12b differs from that in FIGS. 11a and 11b in that block 165 is not designed as a separate assembly unit completely separate from the heater 102, but thermal uncoupling is achieved due to slots 166, 167 and a groove 168. Furthermore, the sensor tip 103′ of the thermocouple 103 is received in a hole.

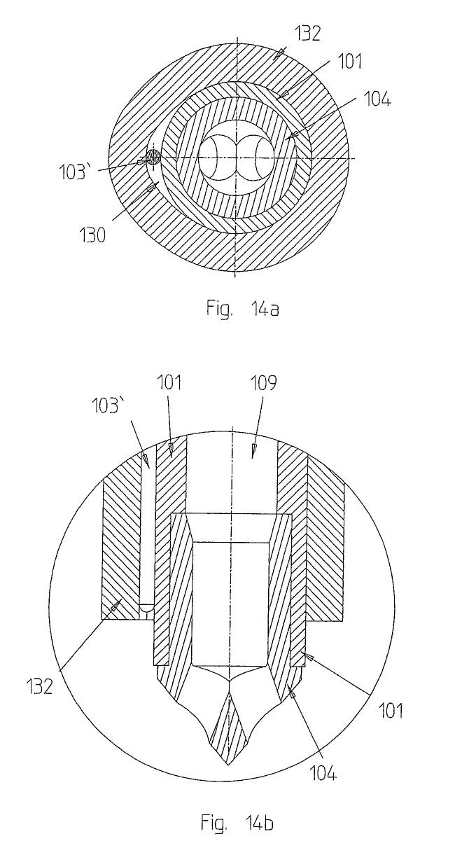

The embodiment according to FIGS. 13a and 13b differs from that in FIGS. 12a and 12b in that block 169 presses the sensor tip 103′ of the thermocouple 103 directly against the material tube 101.

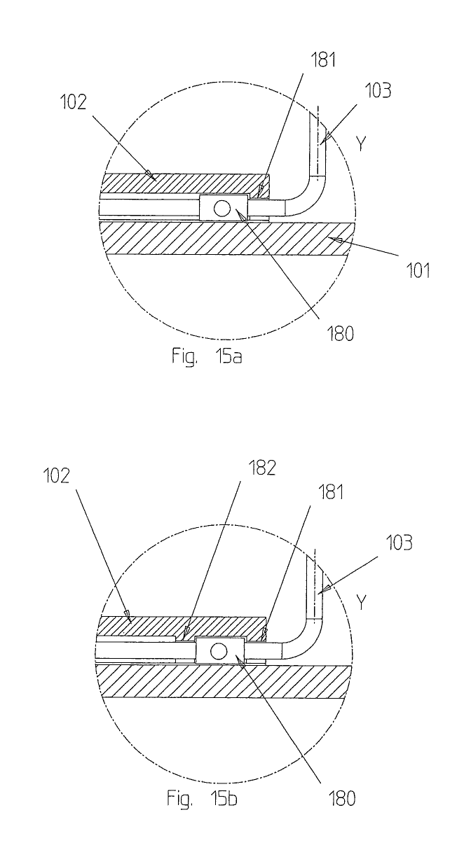

FIG. 14a shows an enlarged section along line C-C in FIG. 1d with the use of a thirteenth embodiment of a clamping mechanism, and FIG. 14b shows the corresponding enlarged view of detail D from the view in FIG. 1d. The clamping mechanism shown here is intended especially for an embodiment with a heater 132 as it is shown in FIG. 1g. The clamping action is brought about here by a reduction of the cross section of the hole passing through the heater 132 in the area in which the sensor tip 103′ of the thermocouple 103 is located. Thus, it becomes unnecessary to provide any groove whatsoever.

FIGS. 15a and 15b show as examples two different embodiments of the present invention, in which the position of the sensor tip of the thermocouple 103 arranged between the material tube 101 and heater 102 is better defined by providing a positioning section, so that it is ensured that when the heater 102 with thermocouple 103 is pushed over the material tube 101, no displacement of the thermocouple 103 will take place. A sleeve 180, which is pushed over the thermocouple 103 and is fixed there, e.g., by welding, soldering or pressing, is used as a positioning section in the embodiments shown. By providing the sleeve 180 at the thermocouple 103, the cross section of the thermocouple is enlarged in the positioning section.

A projection 181, which meshes with the positioning section and which thus blocks a displacement of the thermocouple 103 in the direction in which the heater 102 is attached, is arranged in FIG. 15a at the surface of the heater 102 facing the material tube 101.

In addition to the projection 181 shown in FIG. 15a, a projection 182 is also provided in FIG. 15b, which meshes with the positioning section, so that the displacement of the thermocouple in and opposite the direction in which the heater is attached is blocked. Instead of using projections 181, 182, the same effect could, of course, also be achieved if recesses, which mesh with the positioning section, are provided in the heater 102.

While specific embodiments of the invention have been shown and described in detail to illustrate the application of the principles of the invention, it will be understood that the invention may be embodied otherwise without departing from such principles.

### APPENDIX

### List of Reference Numbers

A-A, B-B, C-C Section line
D, Y Detail view
H Depth
d Diameter
100 Electric heating device
101 Material tube
102, 122, 132 Heater
103 Thermocouple
103′ Sensor tip
104 Injection nozzle
105 Heating element
106, 107 Connector plug
108, 153, 168 Groove
108′ Area of groove
109 Duct
141, 143, 163 Spring element
142, 144, 145, 146, 154, 164 Recess
147 Ring
150, 151, 152 Wedge
160, 165, 169 Block
161, 162 Recess
166, 167 Slots
180 Sleeve
181, 182 Projection

What is claimed is:

1. An electric heating device comprising:
a material tube, through which passes a duct for a flowable material;
a heater for heating the flowable material when this is present in said duct, wherein said heater is pushed over said material tube or is placed around said material tube, so that said material tube is mounted in an opening passing through said heater along a direction in which said material tube extends, and wherein said heater is arranged detachably at said material tube; and
a thermocouple arranged at least in some sections between a surface of said material tube, which surface faces away from said duct, and a heater surface of said heater, which heater surface faces said duct, whereby upon said heater being detached from said material tube, said thermocouple and heater form separate assembly units.

2. An electric heating device in accordance with claim 1, wherein upon said heater being detached from said material tube, the separate thermocouple and heater assembly units are not connected and separate.

3. An electric heating device in accordance with claim 1, wherein said thermocouple is guided at least in some sections in a groove in said material tube or in a groove defined by said heater.

4. An electric heating device in accordance with claim 3, wherein said groove defined by said heater is prepared by deformation or compaction of said heater on a calibrating mandrel with a burr prepared in the form of the groove.

5. An electric heating device in accordance with claim 1, wherein said thermocouple is clamped in one or more sections, including in an area of a sensor tip, between said heater and material tube.

6. An electric heating device in accordance with claim 5, wherein a reduction of the cross section of the opening passing through said heater is present in the area in which said sensor tip is located, so that the clamping action is produced.

7. An electric heating device in accordance with claim 5, wherein an end section of said thermocouple is guided in a groove in said material tube or in a groove in said heater, wherein the depth of said groove decreases in the direction of said sensor tip of said thermocouple to a value that is lower than the diameter of said sensor tip, so that the clamping action is produced.

8. An electric heating device in accordance with claim 5, wherein said heater has a recess, into which a wedge is inserted, wherein said wedge clamps, in the state in which it is inserted into said recess, said sensor tip of said thermocouple between said heater and material tube.

9. An electric heating device in accordance with claim 8, wherein said wedge has a groove for receiving a section of said thermocouple.

10. An electric heating device in accordance with claim 5, wherein said heater comprises a spring element, which presses said sensor tip of said thermocouple onto said material tube, so that the clamping action is produced.

11. An electric heating device in accordance with claim 5, wherein said sensor tip of said thermocouple is clamped between said heater and said material tube indirectly via a heat-conducting block, which is thermally uncoupled from said heater and which has a groove or hole, in which said sensor tip of said thermocouple is mounted.

12. An electric heating device in accordance with claim 1, wherein said thermocouple has a positioning section, in which the cross section of said thermocouple is larger in at least one direction of the cross-sectional area than adjacent sections of said thermocouple, and said heater has means for locking said positioning section against displacement in either direction in which said thermocouple extends.

13. A process for producing an electric heating device, the process comprising the steps of:
providing a material tube;
manufacturing a heater;
providing a thermocouple that is a separate assembly units from the heater;
inserting the thermocouple into a groove of the heater or of the material tube; and
pushing the heater over the material tube with the thermocouple inserted into the groove, wherein the thermocouple inserted into the groove is clamped during or after the heater has been pushed over.

14. A process in accordance with claim 13, wherein the groove is arranged in the heater and is impressed into the heater during a compaction carried out in connection with the manufacture of the heater.

15. An injection molding tool electric heating device comprising:
a material tube defining a duct through which a flowable material may pass;
a heater for heating the flowable material, said heater comprising a heater assembly unit that is pushed over said material tube or is placed around said material tube, whereby said material tube is mounted in an opening, passing through said heater, along a direction in which said material tube extends, and wherein the heater is arranged detachably at said material tube; and
a thermocouple arranged at least in some sections between a surface of said material tube, which surface faces away from said duct, and a heater surface of said heater, which heater surface faces said duct, said thermocouple comprising an assembly unit separate from said heater assembly unit whereby upon the heater being detached from the material tube, the thermocouple assembly unit separates from said heater assembly unit.

16. An injection molding tool electric heating device in accordance with claim 15, wherein said thermocouple is guided at least in some sections in a groove in said material tube or in a groove defined by said heater.

17. An injection molding tool electric heating device in accordance with claim 15, wherein said thermocouple is clamped in one or more sections, including in an area of a sensor tip, between said heater and material tube.

18. An injection molding tool electric heating device in accordance with claim 15, wherein said heater comprises a spring element, which presses a sensor tip of said thermocouple onto said material tube.

19. An injection molding tool electric heating device in accordance with claim 15, wherein a sensor tip of said thermocouple is clamped between said heater and said material tube indirectly via a heat-conducting block, which is thermally uncoupled from said heater and which has a groove or hole, in which said sensor tip of said thermocouple is mounted.

20. An injection molding tool electric heating device in accordance with claim 15, wherein said thermocouple has a positioning section, in which a cross section of said thermocouple is larger in at least one direction of the cross-sectional area than adjacent sections of said thermocouple, and said heater has means for locking said positioning section against displacement in either direction in which said thermocouple extends.
